(19) United States
(12) Patent Application Publication
(10) Pub. No.: US 2025/0146520 A1
(43) Pub. Date: May 8, 2025

(54) SELF-LOCKING TUNING ASSEMBLY WITH SELF-LOCKING TUNING SCREW

(71) Applicant: Suzhou Luxshare Technology Co., Ltd., Suzhou City (CN)

(72) Inventors: Wei WANG, Suzhou City (CN); Yanmei LI, Suzhou City (CN); Guiping GAO, Suzhou City (CN); Xinghua SUN, Suzhou City (CN)

(73) Assignee: Suzhou Luxshare Technology Co., Ltd., Suzhou City (CN)

(21) Appl. No.: 18/588,107

(22) Filed: Feb. 27, 2024

(30) Foreign Application Priority Data
Nov. 2, 2023 (CN) 202322956972.5

(51) Int. Cl. F16B 39/02; H01P 1/00

(52) U.S. Cl. CPC F16B 39/021; H01P 1/00

(57) ABSTRACT

A self-locking tuning assembly includes a tuning screw and a cover plate. The tuning screw includes a head portion and a rod portion. The head portion is provided with a first threaded portion and a second threaded portion. The cover plate defines an opening adapted to the tuning screw. The opening includes a first hole portion and a second hole portion that are communicated. The head portion is at least partially located in the first hole portion. The rod portion is at least partially located in the second hole portion. A hole diameter of the second hole portion is smaller than a hole diameter of the first hole portion. The self-locking tuning assembly improves its self-locking force and installation consistency while maintaining the structural strength thereof.

### CROSS-REFERENCE TO RELATED APPLICATION

This patent application claims priority of a Chinese Patent Application No. 202322956972.5, filed on Nov. 2, 2023 and titled “SELF-LOCKING TUNING ASSEMBLY”, the entire content of which is incorporated herein by reference.

### TECHNICAL FIELD

The present disclosure relates to the field of radio frequency communication technology, and in particular, to a self-locking tuning assembly.

### BACKGROUND

In radio frequency communication products, debugging screws are usually used as debugging components. The traditional locking structure uses screws and nuts to fasten the cover, but this structure is complex to install, costly and heavy. In the related art, there is a self-locking screw, the structural principle of which is to cut grooves on the screw and turn staggered threads at two ends. When the nut is screwed in, the grooves on the self-locking screw generate axial force, thereby locking the entire self-locking screw. However, this self-locking method has relatively poor consistency, small self-locking force, and can easily cause loosening.

Therefore, it is necessary to provide a new self-locking tuning assembly to solve the above problems.

### SUMMARY

An object of the present disclosure is to provide a self-locking tuning assembly that improves self-locking force and consistency while maintaining the existing structural strength.

In order to achieve the above object, the present disclosure adopts the following technical solution: a self-locking tuning assembly, including: a tuning screw including a head portion and a rod portion; the head portion being provided with a first threaded portion and a second threaded portion; and a cover plate defining an opening adapted to the tuning screw; wherein the opening includes a first hole portion and a second hole portion communicating with the first hole portion; the head portion is at least partially located in the first hole portion; the rod portion is at least partially located in the second hole portion; a hole diameter of the second hole portion is smaller than a hole diameter of the first hole portion.

In order to achieve the above object, the present disclosure adopts the following technical solution: a self-locking tuning assembly, including: a tuning screw including a head portion and a rod portion extending from the head portion along a first direction; the head portion being provided with a first threaded portion and a second threaded portion which are spaced apart from each other along the first direction; a cover plate defining an opening and a cavity communicating with the opening along the first direction; the opening configured to receive and fix the tuning screw; and a resonance rod located in the cavity; wherein the opening includes a first hole portion and a second hole portion communicating with the first hole portion along the first direction; a hole diameter of the second hole portion is smaller than a hole diameter of the first hole portion; and when the tuning screw is fixed to the cover plate, the first threaded portion and the second threaded portion is located and fixed in the first hole portion, and the rod portion passes through the second hole portion along the first direction and partially extends into an inside of the resonance rod.

Compared with the prior art, the beneficial effect of the self-locking tuning assembly of the present disclosure is as follows: by using the self-locking tuning screw, it eliminates the nut in the traditional tuning assembly, and the second hole portion having a smaller diameter than the first hole portion is provided on the cover plate. This self-locking tuning assembly improves its self-locking force and installation consistency on the basis of maintaining the structural strength of the assembly; has a simple structure, lower cost, and improved reliability; prevents the tuning screw from rotating out of the cover plate during tuning rotation; and prevents debris from falling into a cavity of the self-locking tuning assembly.

### BRIEF DESCRIPTION OF DRAWINGS

FIG. 1 is a schematic structural view of a self-locking tuning assembly in accordance with a specific embodiment of the present disclosure;

FIG. 2 is a schematic structural view of the self-locking tuning assembly according to a specific embodiment of the present disclosure, wherein a tuning screw is separated; and

FIG. 3 is a schematic structural view of the tuning screw according to a specific embodiment of the present disclosure.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

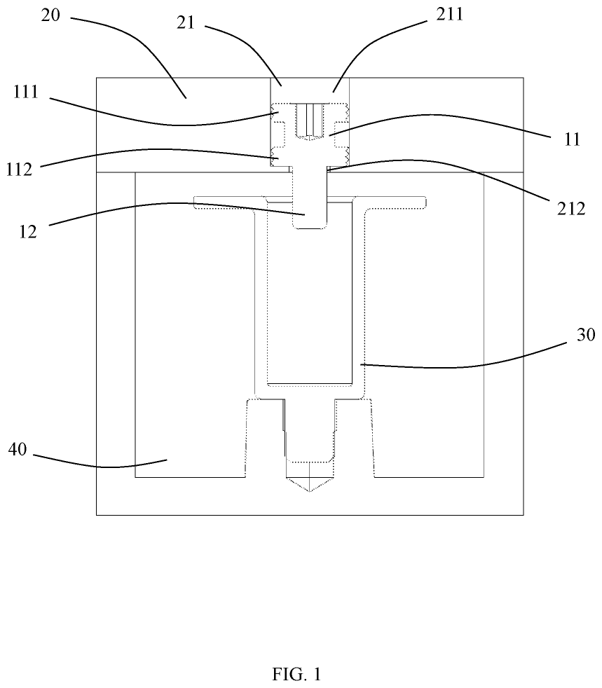

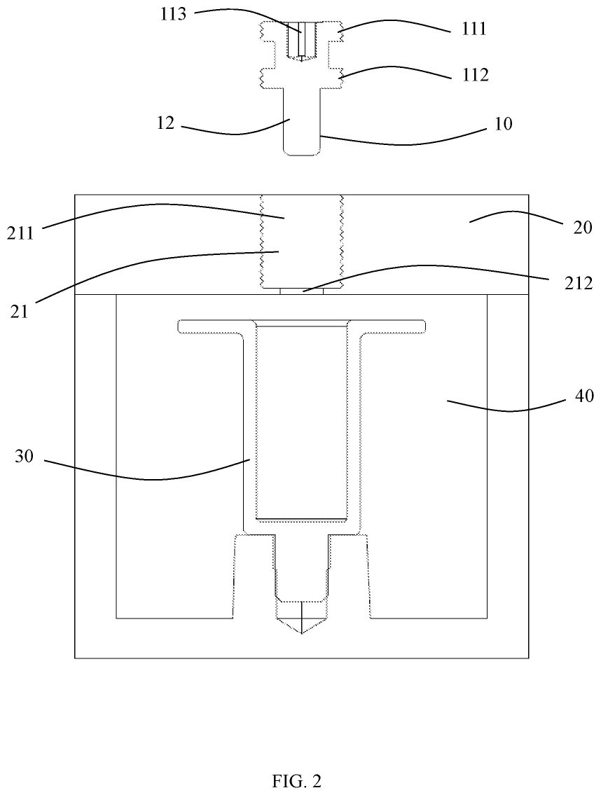

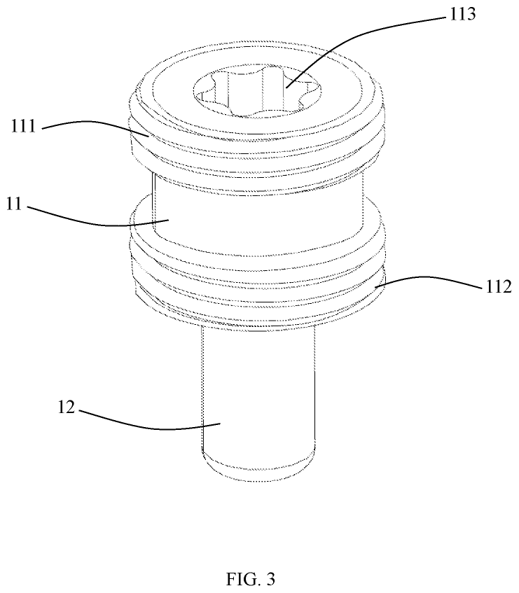

Referring to FIG. 1 to FIG. 3, an embodiment of the present disclosure discloses a self-locking tuning assembly, which includes a tuning screw 10, a cover plate 20, a resonance rod 30 and a cavity 40. The cover plate 20 covers the cavity 40 so as to close the cavity 40. The resonance rod 30 is fixed to an inner bottom of the cavity 40. The tuning screw 10 is mounted to the cover plate 20 and extends at least partially into an inside of the resonance rod 30.

The tuning screw 10 includes a head portion 11 and a rod portion 12. The head portion 11 is provided with a first threaded portion 111 and a second threaded portion 112. The cover plate 20 has an opening 21 in to which the tuning screw 10 fits. The head portion 11 of the tuning screw 10 is located at least partially in the opening 21. Further, the opening 21 includes a first hole portion 211 and a second hole portion 212. The head portion 11 is at least partially located in the first hole portion 211. The rod portion 12 is at least partially located in the second hole portion 212. Both the first threaded portion 111 and the second threaded portion 112 are at least partially located in the first hole portion 211. The second threaded portion 112 is closer to the second hole portion 212 than the first threaded portion 111. The first hole portion 211 has internal threads that are adapted to both the first thread portion 111 and the second thread portion 112, so that the first thread portion 111 and the second thread portion 112 can be firmly screwed into the first hole portion 211.

A hole diameter of the second hole portion 212 is smaller than a hole diameter of the first hole portion 211. The hole diameter of the second hole portion 212 is smaller than an outer diameter of the second thread portion 112, so that the second thread portion 112 can not pass through the second hole portion 212. The hole diameter of the second hole portion 212 is larger than an outer diameter of the rod portion 12. Therefore, the rod portion 12 of the tuning screw 10 can extend into the resonance rod 30 through the first hole portion 211 and the second hole portion 212 along a first direction (for example, atop-to-bottom direction), and the lowermost side of the head portion 11 can only contact the bottom of the first hole portion 211. This prevents the tuning screw 10 from rotating out of the cover plate 20 during the debugging rotation process, and prevents debris from falling into the cavity 40.

The head portion 11 of the tuning screw 10 further defines a mounting groove 113. The mounting groove 113 is recessed from an end of the head portion 11 away from the rod portion 12 toward the rod portion 12, that is, it is recessed downwardly from an upper end of the head portion 11. The mounting groove 113 is used for adjusting the rotation of the tuning screw 10. Further, a longitudinal depth of the mounting groove 113 is smaller than a height of the head portion 11. A lateral width of the mounting groove 113 is smaller than the minimum diameter of the head portion 11.

In some embodiments, a gap is formed between the first threaded portion 111 and the second threaded portion 112. In other words, the head portion 11 includes a neck connected between the first threaded portion 111 and the second threaded portion 112. The head portion 11 is entirely located in the first hole portion 211. Further, the first threaded portion 111 is located at an end of the head portion 11 away from the rod portion 12. The second threaded portion 112 is located at an end of the head portion 11 close to the rod portion 12. The first threaded portion 111 and the second threaded portion 112 have a same pitch and diameter. The diameters of other positions of the head portion 11 are smaller than the diameters of the first threaded portion 111 and the second threaded portion 112. That is to say, the first threaded portion 111 and the second threaded portion 112 are respectively provided at two longitudinal ends of the head portion 11. When the head portion 11 is screwed into the first hole portion 211, there is a certain distance between the first hole portion 211 and a portion of the head portion 11 that is located between the first threaded portion 111 and the second threaded portion 112. After the adjustment of the tuning screw 10 is completed, hot melt glue is driven into the first hole portion 211 of the cover plate 20. The hot melt glue is immersed in the first hole portion 211 and is fixed after cooling.

In some embodiments, two offset and symmetrical radial slots (not shown in the drawings) are further provided between the first threaded portion 111 and the second threaded portion 112. The radial direction here is the transverse direction in the drawings. Further, a radial depth of the radial slot is greater than a radius of the portion of the head portion 11 that is located between the first threaded portion 111 and the second threaded portion 112. This means that the projections of the two radial slots in the longitudinal direction are at least partially overlapped. The overlapping portions of the projections of the two radial slots in the longitudinal direction have at least two symmetry lines. The non-overlapping portions of the projections of the two radial slots in the longitudinal direction have at least two symmetry lines. In this way, when the tuning screw 10 is screwed into the opening 21, the two radial slots generate axial force due to deformation, causing the entire tuning screw 10 to lock. When the hot melt glue is driven in from the first hole portion 211, the hot melt glue will completely immerse the radial slots. After the hot melt glue is cooled, the fixation is completed, and the tuning screw 10 is reinforced to prevent loosening caused by the reduction of the self-locking force generated by the radial slotting due to inconsistent workpiece quality. This can reduce the force of pressing the tuning screw 10 when the tuning screw 10 is screwed into the opening 21, so that the tuning screw 10 can be easily screwed into the first hole portion 211. Besides, the two radial slots generate greater rebound force, thereby improving the locking strength.

In some embodiments, the mounting groove 113 communicates with the radial slot. In this way, the hot melt glue can be applied directly from the bottom of the mounting groove 113 into the radial slot, and the hot melt glue can completely immerse the radial slot and the first hole portion 211.

In this embodiment, the tuning screw 10 is made of alloy. A surface of the tuning screw 10 is passivated and waxed in order to increase the oxidation resistance of the tuning screw 10. The cover plate 20 is made of alloy. A surface of the cover plate 20 is silver-coated or copper-coated.

The metal sheet filter of this embodiment can be applied to radio frequency products, including but not limited to filters, duplexers, combiners, transmitters, tower-mounted amplifiers, etc.

In summary, compared with the prior art, the self-locking tuning assembly of the present disclosure has the following advantages: by adopting the self-locking tuning screw 10, it eliminates the nut in the traditional tuning assembly; and the cover plate 20 is provided with the second hole portion 212 having a smaller hole diameter than the first hole portion 211. The radial slot is provided between the first hole portion 211 and the second hole portion 212 to reduce the force pressing the tuning screw 10 when the tuning screw 10 is screwed into the opening 21. The self-locking tuning assembly improves its self-locking force and installation consistency while maintaining the structural strength of the assembly. The structure is simple, the cost is lower, and the reliability is improved. It can also prevent the tuning screw 10 from rotating out of the cover plate 20 during the debugging rotation process, and prevent the debris from falling into the cavity 40.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A self-locking tuning assembly, comprising:
a tuning screw comprising a head portion and a rod portion; the head portion being provided with a first threaded portion and a second threaded portion; and
a cover plate defining an opening adapted to the tuning screw;
wherein the opening comprises a first hole portion and a second hole portion communicating with the first hole portion; the head portion is at least partially located in the first hole portion; the rod portion is at least partially located in the second hole portion; a hole diameter of the second hole portion is smaller than a hole diameter of the first hole portion.

2. The self-locking tuning assembly according to claim 1, wherein the second threaded portion is close to the second hole portion relative to the first threaded portion; the hole diameter of the second hole portion is smaller than an outer diameter of the second thread portion.

3. The self-locking tuning assembly according to claim 1, wherein the hole diameter of the second hole portion is larger than an outer diameter of the rod portion.

4. The self-locking tuning assembly according to claim 1, wherein a gap is formed between the first threaded portion and the second threaded portion.

5. The self-locking tuning assembly according to claim 4, wherein the first threaded portion is located at an end of the head portion away from the rod portion; the second threaded portion is located at an end of the head portion close to the rod portion.

6. The self-locking tuning assembly according to claim 1, wherein the first threaded portion and the second threaded portion have a same pitch and diameter.

7. The self-locking tuning assembly according to claim 1, wherein the head portion defines a mounting groove; the mounting groove is recessed from an end of the head portion away from the rod portion toward the rod portion.

8. The self-locking tuning assembly according to claim 7, wherein a longitudinal depth of the mounting groove is less than a height of the head portion; a lateral width of the mounting groove is smaller than a minimum diameter of the head portion.

9. The self-locking tuning assembly according to claim 1, wherein the tuning screw is made of alloy; a surface of the tuning screw is passivated and waxed.

10. The self-locking tuning assembly according to claim 1, wherein the cover plate is made of alloy; a surface of the cover plate is silver-coated or copper-coated.

11. A self-locking tuning assembly, comprising:
a tuning screw comprising a head portion and a rod portion extending from the head portion along a first direction; the head portion being provided with a first threaded portion and a second threaded portion which are spaced apart from each other along the first direction;
a cover plate defining an opening and a cavity communicating with the opening along the first direction; the opening configured to receive and fix the tuning screw; and
a resonance rod located in the cavity;
wherein the opening comprises a first hole portion and a second hole portion communicating with the first hole portion along the first direction; a hole diameter of the second hole portion is smaller than a hole diameter of the first hole portion; and
when the tuning screw is fixed to the cover plate, the first threaded portion and the second threaded portion is located and fixed in the first hole portion, and the rod portion passes through the second hole portion along the first direction and partially extends into an inside of the resonance rod.

12. The self-locking tuning assembly according to claim 11, wherein the second threaded portion is close to the second hole portion relative to the first threaded portion; the hole diameter of the second hole portion is smaller than an outer diameter of the second thread portion so that the second thread portion is not allowed to pass through the second hole portion.

13. The self-locking tuning assembly according to claim 11, further comprising a hot melt glue filled in the opening.

14. The self-locking tuning assembly according to claim 11, wherein the head portion comprises a neck connected between the first threaded portion and the second threaded portion.

15. The self-locking tuning assembly according to claim 14, wherein the first threaded portion is located at an end of the head portion away from the rod portion; the second threaded portion is located at an end of the head portion close to the rod portion.

16. The self-locking tuning assembly according to claim 11, wherein the first threaded portion and the second threaded portion have a same pitch and diameter.

17. The self-locking tuning assembly according to claim 11, wherein the head portion defines a mounting groove; the mounting groove is recessed from an end of the head portion away from the rod portion toward the rod portion.

18. The self-locking tuning assembly according to claim 17, wherein a longitudinal depth of the mounting groove is less than a height of the head portion; a lateral width of the mounting groove is smaller than a minimum diameter of the head portion.

19. The self-locking tuning assembly according to claim 11, wherein the tuning screw is made of alloy; a surface of the tuning screw is passivated and waxed.

20. The self-locking tuning assembly according to claim 11, wherein the cover plate is made of alloy; a surface of the cover plate is silver-coated or copper-coated.
